(19) United States
(12) Patent Application Publication
(10) Pub. No.: US 2003/0182161 A1
(43) Pub. Date: Sep. 25, 2003

(54) Interactive system for providing information and optimizing the attendance in the areas of health and related ones

(76) Inventors: Amauri Hernandes Vanderlei, Vinhedo (BR); Antonio Carlos da Silva Rocha, Vinhedo (BR); Flavio Sartori Junior, Vinhedo (BR); Marcos Roberto Eliseu, Vinhedo (BR); Marcos Jose Saab, Vinhedo (BR)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/353,076

(22) Filed: Jan. 29, 2003

(30) Foreign Application Priority Data
Jan. 29, 2002 (BR) PI 0200290

(51) Int. Cl. G06F 17/60

(52) U.S. Cl. 705/2

(57) ABSTRACT

An interactive system for providing information and optimizing the service in the health areas and those related thereto able to organize and provide, in an interactive way, information and instructional matters of interest to users (patients/clients) (5) on subjects concerning the health areas and those related thereto, said information being provided by an interactive software (3) (the registration application therefor having already been filed by the inventor of said system himself), showing narrated structured texts, explanatory videos and photographs related to several pathologies, its treatments, surgeries and the like, in a screen (2), as well as the introduction of the professional on duty (6) of the medical area or another area related thereto, his/her resume, a blank space for the most frequent doubts, as well as a space for advertising by advertisers (12) registered in the system, said software (3) being associated to an equipment (1) to be installed in any environment that is easily accessed by the users interested in the information therein, wherein, after said information is handled and attained, said user (5), now more informed, becomes more receptive, thus assisting the professional (5) in his/her consultation in a substantially interactive process, thus improving the rates of feedback acceptance and respect to the proposed treatments or surgeries, also providing spaces for disclosing products, services and researches that aim at generating a greater interest and benefits.

### DISCLOSURE OF THE INVENTION

The present specification is related to the patent for the invention of a system that organizes and provides, in an interactive way, information and instructive matters of interest to users (patients/clients) on subjects connected to the areas of health and those related thereto. The system facilitates the communication between professionals and users (patients/clients), in a pleasant and simple way, of subjects that are of interest to both, clarifying them on popular myths and beliefs.

The users (patients/clients) of this system will be well informed and clarified by the system, thus substantially contributing for the performance of the professionals of the areas that will serve them.

This range of information is available in a simplified clear and objective language by an interactive software (the registration application therefor having already been filed by the inventor of said system himself), comprised of narrated structured texts, explanatory videos and photographs.

It has been devised to communicate and inform the users (patients/clients) on the subjects that are of interest to them, being extremely simplified to operate and navigate in view of its shape and association with multimedia equipment (e.g., kiosks) that use touch screens that are sensitive to the touch of the finger, or even by any other computerized equipment compatible therewith.

For this reason, it encloses the public accustomed to the use of computers, both older users (patients/clients) and/or those less instructed and therefore less accustomed to use new technology. It can be installed in any environment that is easily accessed by the users interested in the information contained therein.

All the multimedia equipment used have an attractive “design” that induces the user (patient/client) to be stimulated to interact with the software in connection with information contained therein.

The difficulties faced by the citizen when he/she needs to be about the subjects connected to the area of health and those related thereto, in an area which is notably suffocated by misinformation, are known.

It is, therefore, exactly in this sense that the inventive system, aims at clarifying the users (patients/clients) by producing significant results in the understanding and elimination of doubts related to the several subjects connected to the health, in its compromise with the preventive actions everyday, as well as the recommendation of professionals of these areas.

Besides the social benefit of adding knowledge and clarification to many users who cannot access such information in the proposed way, the system is able to turn a language, which is many times too technical for the ears of the users, into a simple and objective communication, especially designed for the latter.

It also allows the professionals of the areas served by the system to optimize their time, improve the rates of feedback, acceptance and respect to the considered treatments, because more clarified users (patients/clients) tend to be more receptive, as shown by all the rates of developed countries.

This system also provides spaces for disclosing products, services and researches that aim at the generation of a greater interest and benefits to the user, thus allowing him/her to have a greater access to the information about same.

Thanks to said exchange of information, in an interactive way, offered by the system, it is possible to trace the profile of the user, to clarify doubts in relation to the treatments, the characteristics of the products used, more frequent pathologies, to improve the informative and instructional contents, to identify and specify which type of information can or must be improved, complemented or still enclosed to benefit the user, to identify the use of a certain product and/or service by the user and possible improvements in said product for the benefit thereof such as, for example, the identification of the side effect “head-ache” caused by a certain medicament or a “eye irritation” caused by a certain contact lens, and so on.

All these quantified and qualified data will bring about great benefits to the area of health, its users and professionals in the social and economical fields.

In a global way, the system is better understood and detailed through the accompanying drawings, wherein:

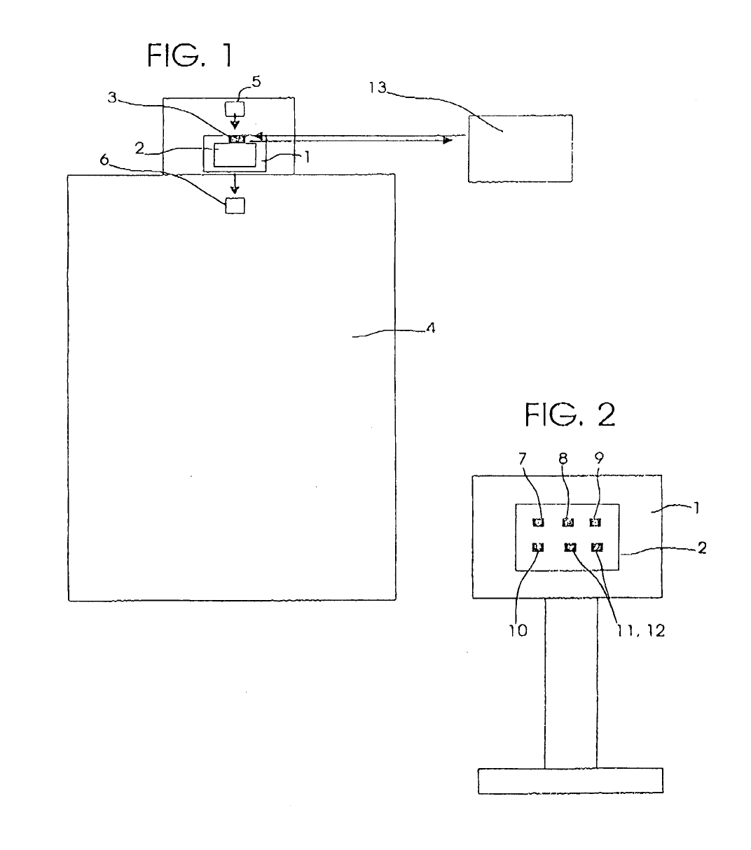

FIG. 1 is a flowchart of the system, identifying the steps covered, from the consultation made by the user (patient/client), through the screen of the equipment, examination by the professional of the areas of health and those related thereto for the diagnosis of the case, to the recommendation of a treatment and future solution for the problem of the user;

FIG. 2 is an illustrative schematic view of the screen of a kiosk integral with the system.

In accordance with the accompanying drawings, the interactive system for providing information and optimizing the service in the health areas and those related thereto object of the present patent application is comprised of a multimedia hardware (e.g., kiosk) (1) equipped with a touch screen (2), which can be also provided with a mouse, a keyboard, a printer, a magnetic card reader and other peripherals as required, associated with a software (3) especially developed to facilitate the interaction of the user with the informative and instructional contents, containing information on the health area and/or those related thereto that can accessed through icons shown on the same screen (2).

Said equipment (1), in its turn, can be easily installed in an easy-to-access place by the user such as, for example, lobbies of physician's offices, public and/or particular clinics or hospitals and others (4), so that it can be handled by the user (5).

Thus, a first icon (7) shown on the screen (2) of the equipment (1) is related to the main subjects of interest to the user in the health area, explained in details by a narrator by using, for example, an explanatory video, a second icon (8) which shows, in its turn, in an exhibiting video the procedures adopted in the area of health for the purposes of illustration and elucidation; a third icon (9) related to the spaces for the professionals of the health area to disclose their works, resume, specialization, and the like, and same can be personalized through the insertion of a logo, etc. A fourth icon (10) is related to the spaces where the user can find the most common doubts on the subjects of the health area and the respective explanations therefor.

The software (3) also contains icons (11) with spaces available for the disclosure of suppliers and/or partners (12) (physician's office, public and/or particular clinic or hospital and companies in that field, etc.) (4) such as laboratories, optician's, drugstores, health plans, manufacturers of equipment and the like.

Such suppliers/partners (12) will be duly registered by the system and will disclose advertisements and/or information on its products and services through the software (3).

In its turn, the equipment (hardware) (1) can be easily connected within the broad band, either through fiber optics, telephonic line, satellite or another system, to a controlling exchange (13) able to manage all the information and spaces contained in the software (3), for registering suppliers/partners (12), update and change the informative contents and disclosure spaces, as well as to quantify and issue reports on all the variables allowed by the equipment and software.

Thus, as is shown in the flowchart of FIG. 1, the user (5) uses the equipment (1) through its touch screen (2) which is sensitive to the touch of finger or through a keyboard and a mouse, opening the icons (7), (8), (9) e (10), according to his/her need or convenience.

The user, through the help of icons of the subjects to be consulted, gets the information on the target subjects which are duly explained on the screen (2), speeding up and supplying more elements for the professional to analyze his/her case.

After said consultation Is made, the user (5), after “commanding” through the screen (2) the information that he/she need, is finally interview and/or examined by the professional of the area of health or those related thereto, (6) having important information for the possible solution of his/her problem, what may bring him more easiness, clarification and safety due to the previous interaction with the system.

The user (5) can even be introduced to the professional (5) before the consultation, by clicking the icon (9), thus getting an idea of his works, resume, specialization, courses attended and even the structure of his company (e.g., his clinic), shown on the screen (2).

Such procedure modernizes the concept of servicing and informing, providing the user (5) with more clarification and confidence, positively reinforcing the image of the professional of the areas served by the system, the doctor's office, clinic or hospital, for example (4).

The system becomes interactive exactly in view of the fact that the user (5), when consulting the professional of the area (6), becomes confident because of the information previously obtained and can, together with said professional (6), facilitate eventual healing, corrective and preventive procedures and the possibilities of intervention.

The social benefits become evident with information directed to the users with an easy interactive language, accessed by the public, speeding up and assisting the professional of the area (6) during his interaction, intervention and servicing.

With the implementation of this system, the use of printed media can be advantageously replaced, which media are generally displayed in waiting rooms and lobbies, such as magazines, commercial brochures elaborated by advertising agencies or even electronic media directly disclosed by companies acting in the health area, which do not have the interactivity and multiplicity of details of the inventive system, which is a novel valuable media, able to contribute with the disclosure of information in the social area and innovate the communication between users and professionals generating a new form of relationship in the health area.

1. An interactive system for providing information and optimizing the service in the health areas and those related thereto, comprised of a hardware such as, for example, a multimedia kiosk (1) provided with a touch screen (2) which can be also provided with a mouse, a keyboard, a printer, a magnetic card reader and other peripherals, as required, associated to a software (3), characterized in that it promotes the interaction of the user with the informative and instructional contents, information of the health area and/or those related thereto, that can be accessed through icons shown on the same screen (2); wherein said equipment (1) is to be installed in a place that can be easily accessed by the user (5) such as, for example, the lobby of physician's offices, public and/or particular clinics or hospitals and the like (4), so that it can be handled by the user (5) before he/she is examined by the doctor or professional of the health; wherein the screen (2) of the equipment (1) shows an icon (7) related to the main subjects of interest to the user (5) in the health area, explained in details by a narrator through with the use, for example, of an exhibiting video; a second icon (8) which shows, in its turn, in an exhibiting video the procedures adopted in the area of health for the purposes of illustration and elucidation; a third icon (9) related to the spaces for the professionals of the health area to disclose their works, resume, specialization, and the like, and same can be personalized through the insertion of a logo, etc.; and a fourth icon (10) related to the spaces where the user can find the most common doubts on the subjects of the health area and the respective explanations therefor, the screen (2) also showing icons (11) with available space for the disclosure of suppliers and/or partners (12) (physician's offices, public and/or particular clinic or hospital and companies in that field, etc.) (4) such as laboratories, optician's, drugstores, health plans, manufacturers of equipment and the like duly registered by the system and disclosing advertisements and/or information on its products and services through the software (3).

2. The interactive system for providing information and optimizing the service in the health areas and those related thereto according to claim 1, characterized in that the equipment (hardware) (1) can be easily connected within the broad band, either through fiber optics, telephonic line, satellite or another system, to a controlling exchange (13) able to manage all the information and spaces contained in the software (3), for registering suppliers/partners (12), update and change the informative contents and disclosure spaces, as well as to quantify and issue reports on all the variables allowed by the equipment and software.

3. The interactive system for providing information and optimizing the service in the health areas and those related thereto according to claims 1 and 2, characterized in that there is an interaction between the patient (5) and the professional of the area, physician or the like, thus facilitating eventual healing, corrective and preventive procedures and the possibilities of surgical intervention, thanks to the information stored in the software (3) and previously obtained by the patient (5) when clicking the icons (7), (8), (9), (10) e (11), shown on the screen (2) of the equipment (1).
